(19) United States
(12) Patent Application Publication
(10) Pub. No.: US 2009/0034544 A1
(43) Pub. Date: Feb. 5, 2009

(54) State-based Communication Station Control System and Method

(76) Inventor: Vladimir Butenko, Mill Valley, CA (US)

Correspondence Address: INTELLECTUAL PROPERTY LAW GROUP LLP, 12 SOUTH FIRST STREET, SUITE 1205, SAN JOSE, CA, 95113, US

(21) Appl. No.: 11/833,913

(22) Filed: Aug. 3, 2007

(51) Int. Cl. H04L 12/28

(52) U.S. Cl. 370/401

(57) ABSTRACT

State-based communication stations are capable of operating on two or more “states.” Principles of the present invention are used to allow the functionality that a multi-state communication station is equipped to change as a result of the current state of the station. The functionality of modern communication stations remains much less hindered by the physical limitations of the stations' physical construction and design. While the number of buttons in a communication station remains the same, the number of functions that such buttons may execute is multiplied by the number of “states” that exist for the station.

### BACKGROUND

1. Field of the Invention

The invention relates generally to state-based communication systems. More specifically, the invention relates to control systems that manage and facilitate communications where communications stations are characterized as having a plurality of signaling “states,” and where station functionality is dependent on the current state of the station.

2. Related Art

Modern day telephony and telecommunication networks have revolutionized the way that human societies are structured and how members of such societies conduct their daily lives. Due to the increased dependence that society at large has on such telecommunication networks, there is an ever-increasing need for a greater degree of efficiency regarding the quality of communications across these networks.

A telecommunication network generally comprises a number of end-points that may communicate with one another. A number of methods may be implemented in order to provide communication paths between end-points on a network through which data may be transmitted. Such methods include traditional circuit-switching and packet-switching protocols. In addition, due to the increased popularity of the Internet as a communications medium, Voice-over-IP (“VoIP”) technology is also becoming increasingly popular.

Many modern telephony end-points utilize a set of “address” buttons, but those buttons are configured to always perform the same function (usually dialing a number). However, in a multi-state communication network, certain functions (such as dialing numbers) make sense only when an end-point is in a particular state. End-point stations in communication systems presently lack the ability to modify button action in response to a current state of a communication end-point. Therefore, there exists a need for a method and system of initiating state-based communications between multi-state end points.

### SUMMARY

An object of the present invention is to provide a control system that is designed to facilitate communications with an end-point communication station that can be in two or more “states.” The functionality of the controls that the station is equipped with depends on the current station “state.” Thus, various embodiments of the present invention provide a solution for communication across a communication network utilizing state-base functionality at network end-points.

A further object of the invention is to maximize available functionality of communication systems without adding a relatively high level of complexity. Embodiments of the invention allow the physical controls of modern communication stations to have a greater degree of functionality by allowing the number of buttons in a communication station to remain the same, while the number of functions that such buttons may execute is multiplied by the number of “states” that exist for an end-point station. Although these embodiments involve a greater degree of complexity with regard to past communication systems, the principles of the present invention are not difficult to implement by those skilled in the art since the proposed sample “states” are easily and intuitively understood by even inexperienced end-users.

According to an embodiment of the present invention, there is a system which comprises: a first communication module that switches between different communication states; and a communication control function mapped to a target address that is assigned to a second communication module; wherein the present functionality of the control function is dependent upon the present state of the first communication module.

According to another embodiment of the present invention, there is a communication control system having state-dependent functionality. The system comprises: a primary communication module capable of switching between different states, wherein said primary communication module is assigned a first address; and a transmission control function configured to initiate, redirect and transfer transmissions to a second address assigned to a target communication module, and configured to execute a specific function depending upon a present state of the primary communication module.

According to another embodiment of the present invention, there is a method of state-dependent communication. The method comprises: mapping a network address to a transmission control function, wherein the network address is assigned to a target communication module; and executing the transmission control function, wherein said executing step results in the transmission control function: redirecting a transmission to the target communication module when a primary communication module is receiving a communication request from another communication module; transferring an active transmission to the target communication module when the primary communication module is engaging in the active transmission with another communication module; and initiating a transmission with the target communication module when the primary communication module is not engaging in any other active transmissions and is not receiving any new transmissions.

The foregoing has outlined some of the more pertinent objects and features of the present invention. These objects should be construed to be merely illustrative of some of the more prominent features and applications of the invention. Many other beneficial results can be attained by applying the disclosed invention in a different manner or modifying the invention as will be described. Accordingly, other embodiments, objects and a fuller understanding of the invention may be had by referring to the remainder of the present document.

### BRIEF DESCRIPTION OF THE DRAWINGS

Other features and advantages of the invention, both as to its implementation and operation, will best be understood and appreciated by those of ordinary skill in the art upon consideration of the following detailed description and accompanying drawings, in which:

FIG. 1 is a simplified diagram showing a telephony communications network according to an embodiment of the present invention;

FIG. 2 illustrates a method of communication among communication modules according to an embodiment of the present invention;

FIGS. 3A and 3B shows an embodiment of a method of implementation of a communications system according to an embodiment of the present invention;

FIGS. 4A and 4B demonstrate an alternative embodiment of a method of implementation of a communications system according to an embodiment of the present invention;

FIGS. 5A and 5B shows another alternative embodiment of a method of implementation of a communications system according to an embodiment of the present invention; and

FIG. 6 is a simplified flow chart showing a method according to an embodiment of the present invention.

### DETAILED DESCRIPTION OF SPECIFIC EMBODIMENTS OF THE INVENTION

### Overview of Communication “States”

A first embodiment of the present invention provides a method and system of state-based communications that may be utilized by multi-state communication modules. A communication end-point in a communications network enters various “states” depending on the type of function or activity that the end-point station is engaging in at any particular time. A transition from one state to another signals that a specific, pre-defined action must be undertaken.

In another embodiment, communication end-points may have at any one time one of a plurality of different states. Examples of such states include, but are not limited to, the following:
(1) AUTHORIZE CALL ATTEMPT;
(2) ALERTING;
(3) CONNECTED;
(4) DISCONNECTED;
(5) REDIRECT CALL DELIVERY;
(6) TRANSFER CALL ATTEMPT;
(7) BLIND TRANSFER;
(8) IDLE;
(9) HOLD.
   This list is not exhaustive, but rather representative of some of the many states that a station may transfer into pursuant to the present embodiment.

With reference to the previous embodiment, a communication end-point may enter into an “AUTHORIZE CALL ATTEMPT” state, wherein at least one communication request is sent from one communication end-point to another. In an “ALERTING” state, at least one incoming call (communication request) is received by the end-point station, and this call has not yet been answered or rejected. When a station accepts a communication request, the station transfers to the “CONNECTED” state. This state discloses that the end-point is currently connected to one or more open communication channels.

In another embodiment, when a communication channel between two previously communicating end-points is closed, the stations transfer to the “DISCONNECTED” state. This state discloses that the end-point is no longer connected to an open communication channel. The DISCONNECTED state may also be used to signal that resources previously allocated for transmitting, processing, etc. the call during the CONNECTED state should be released so that they will be available to other stations.

In another embodiment of the present invention, when a station transfers to the “REDIRECT CALL DELIVERY” state, it forwards the network address of another station that may be available to receive the call before it has begun processing the call. When a station transfers to the “TRANSFER CALL ATTEMPT” state, it forwards the call to another station that is available to receive the call. A station may enter the TRANSFER CALL ATTEMPT state even though it has already begun processing the call. In a “BLIND TRANSFER” state, the transferring station (after it has begun processing the call) forwards the network address of another station that may be available to receive the call, and then immediately transfers into the DISCONNECTED state.

In yet another embodiment of the present technology, a multi-state communication end-point may enter into an “IDLE” state, during which no transmission is occurring in the transmission line. This state is often used to define the time between either the transmission or receipt of multiple data packets. In a further embodiment, an end-point in the “HOLD” state is already connected to one or more end-points through communication channels that are presently open, but through which no information is currently being sent. An embodiment of the present invention may be further expanded such that IDLE or HOLD states precede various REDIRECT CALL DELIVERY, TRANSFER CALL ATTEMPT and BLIND TRANSFER functions.

It should be appreciated by those skilled in the art that the aforementioned states are merely illustrative of the states that a multi-state communication station according to embodiments of the present invention may enter into. It should also be understood that three primary communication states (“on-call”, “alerting” and “idle”) are utilized throughout this Detailed Disclosure for purposes of describing various embodiments according to the present technology. However, embodiments of the present invention may be implemented with various types of multi-state communication stations and with a varying degree of communication states, depending on the communication needs of a user. Indeed, various types of communication media may be implemented so as to configure embodiments of the present invention for use across specific lines of communication.

### Circuit-Switching Networks

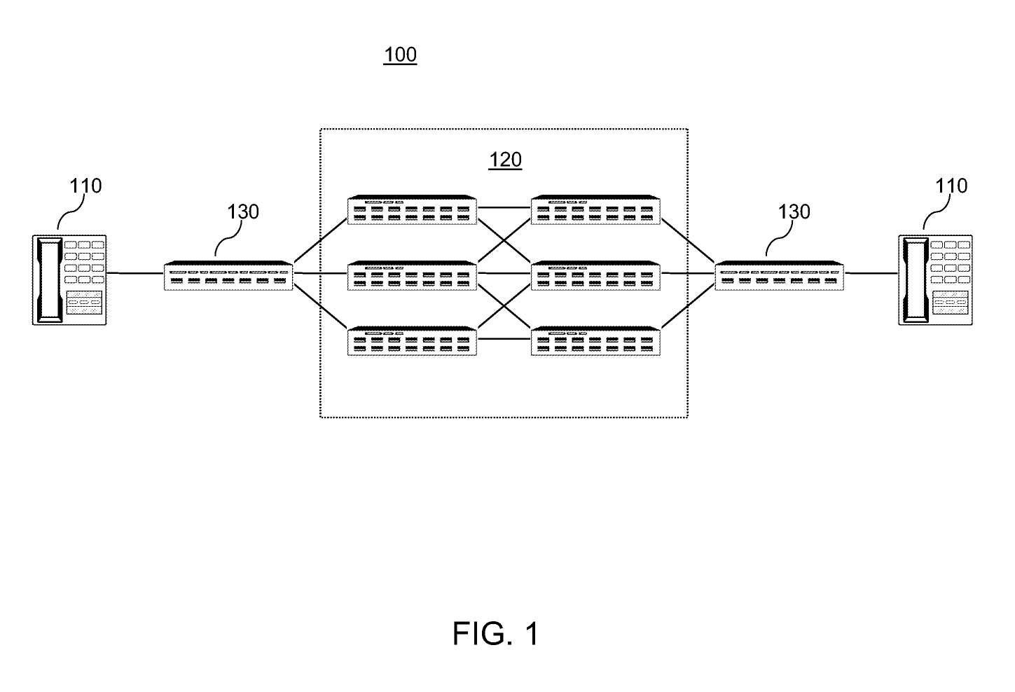

One embodiment of the present technology utilizes a circuit-switching network to provide a means of communication between state-based end-points. FIG. 1 is a representation of a simplified Public Switched Telephone Network (“PSTN”) 100 communications configuration in accordance with principals of the present embodiment. The PSTN 100 functions as a “circuit-switched” network in that a particular circuit within the network is dedicated to transmitting electronic data between two end-points 110 on the network. When a connection between the two communicating end-points 110 is severed, the circuit is then free to be utilized for facilitating communication between other end-points.

With reference still to FIG. 1, the data connection may exist on a physical circuit operating on a particular channel within the PSTN 100, where said channel corresponds to several switching points 120 for transmitting data between PSTN endpoints 110. In another embodiment, additional routers 130 may be utilized to route transmissions from the switching points 120 to the network end-points 110. In this way, a single router may be shared between a plurality of network end-points.

In one embodiment of the present invention, the PSTN 100 is capable of time division multiplexing (“TDM”) many digitally sampled voice channels using well-known physical data formats. TDM allows two or more signals or bit streams to be transmitted in one communication channel by causing multiplexed frames of the transmissions to physically taking turns on the channel.

In another embodiment, the data connection may also exist on a “virtual” circuit in an asynchronous transfer mode (“ATM”). ATM is a communications architecture that relays small, fixed length data packets called cells, which are themselves comprised of header and payload data. Each virtual circuit is allotted a specific amount of bandwidth on the ATM trunk. ATM switch manage the transmission of cells through the ATM network. An ATM switch accepts an incoming cell from an ATM endpoint or another ATM switch, and then analyzes and updates the cell header information. The ATM switch then directs the cell to an output interface where it is routed to its destination address.

With reference still to FIG. 1, a given data connection may utilize both physical and virtual circuits for the same transmission. Specifically, a particular connection path may consist of one or more physical circuits in the PSTN 100 for certain parts of the connection, while the remainder of the communication path is constructed by one or more virtual circuits. Also, an existing data connection is capable of being dynamically re-routed to different circuits, even when a transmission between two network end-points is already in progress.

It should be further understood by those skilled in the art that a network access device, according to an embodiment of the present technology, coupled to the PSTN 100 may communicate using analog signaling, Integrated Services Digital Network (“ISDN”) channels, or other signaling formats. In addition to transmitting audio data, the access network of the PSTN 100 transmits and receives line signals. These signals relay information about a specific connection. Examples of such line signals include, but are not limited to: off-hook, on-hook, duration, voltage, frequency of meter pulse, ringing current, and dial pulse.

In an alternative embodiment, a network access device does not perform call switching or call processing. Instead, the device merely transmits data via the ATP trunk to a defined switching point among a plurality of switching points 120 in the PSTN 100, and communicates with the switching point by utilizing a network access protocol that utilizes command sets to request channels between the network access device and a switching point among the plurality of switching points 120. The switching point responds to the request by de-allocating such channels from previously assigned end-points on the network, and then re-allocating these channels for use by the requesting network access device.

### Packet-Switching Networks

Another embodiment of the present technology utilizes a packet switching network to transfer data between state-based communication modules. Packet-switched data transmission protocols involve communication systems that utilize a packet-switching method of establishing communication systems rather than the older circuit-switching method. Such communication systems do not need dedicated circuits or circuit switches, as the channels of communication between end-points are constructed on-the-fly. An example of a packet voice transmission protocol utilized for telephony communications is Voice-Over-IP (“VoIP”), which is compliant with the Internet's protocol for transferring data.

Instead of allocating circuits for data streams (as in a circuit-switching network), packet-switching divides a stream of data into a plurality of parcels of data that can be individually routed over the network. These parcels of data are known as “packets.” Each packet of data contains information that describes the packet's source and destination. In one embodiment of the present technology, switching points, or routers, within the network analyze this information, and then find and select an available channel of communication through which to route the packet. In a further embodiment, the network communication channels are built on-the-fly, thus providing a relatively efficient and flexible means of routing packet-switched data.

Another embodiment of the present invention teaches that circuit-switched calls between state based communication modules may be routed over a packet-switching network by using gateways and call agents. A gateway transfers information between at least one ingress port and at least one egress port, where said egress port links to a packet-switching network. A gateway is generally capable of processing data calls received at an ingress port. It establishes a network access session and then allocates a modem resource for that session. The modem resource translates data packets so that they comply with the format used on the trunk for transmitting the data call. For example, the modem resource may be configured to modulate outgoing audio signals in a particular format (such as pulse-code-modulation). In a second example, the modem resource is further configured to demodulate incoming audio signals.

In another embodiment, a gateway may also allocate, or otherwise call, a resource that is capable of utilizing a compression/decompression algorithm (“codec”) when a relatively large amount of data is to be transmitted in a single data call. The codec divides the data call into individual data packets, and compresses them prior to transmission; the codec may also perform a buffer function before the data is transmitted from the egress port. Finally, the codec performs a receiving function, in that it decompresses incoming data packets into a usable format (i.e., it recovers the original data as it existed before being compressed). The data is then buffered before being transmitted to a particular channel, such as on the PSTN 100.

An alternative embodiment of the present invention implements a packet-based network that utilizes call agents, which perform various call processing functions. These call agents are somewhat analogous to a circuit switch in a circuit-switched network; however, call agents and circuit switches use different methods of processing a call. In one embodiment, these call agents are configured to play a managerial function in the network, such that they control the network's gateways (e.g., by using a gateway control protocol).

It should be understood by those skilled in the art that the call agents utilized by various embodiments of the present invention may be further configured to meet the needs of one implementing principles of the present technology. For example, call agents may be configured to performing a myriad of functions, such as processing data calls and communicating with gateways, circuit switches, and even other call agents. In addition, such call agents may be further configured to allocate and deallocate gateways, and otherwise direct and manage network traffic. Indeed, in one embodiment, call agents are implemented to monitor communication by a state-based communication end-point and to manage call authorization and billing procedures.

In an alternative embodiment, call agents are capable of processing data calls on trunks without physically terminating those trunks. First, the call agents are configured to manage the trunks of each gateway. They generate and send directions on how specific channels should be allocated, and they pinpoint to which receiving gateways data calls should be sent. The call agents then relay this information to the gateways that are directed to send the data calls through the network.

In one embodiment, the format parameters for conducting the actual transmission (e.g., data transmission rate, method of encryption/decryption, specific codec) are decided by the communicating gateways rather than the call agent. Once transmission between the gateways initiates, the data call continues without interruption until the gateways terminate the call; this means that the call agent cannot intervene during transmission of the data call. However, once the gateways terminate the call, the call agent is notified of such. The call agent, again in its managerial role, directs the gateways to free up any memory, and otherwise reallocate resources, used during the call. In an alternative embodiment, a call agent communicates to the PSTN switches 120 that the lines of communication dedicated to the terminated call are no longer needed (and therefore may be reallocated).

### Detailed Methods of Implementation

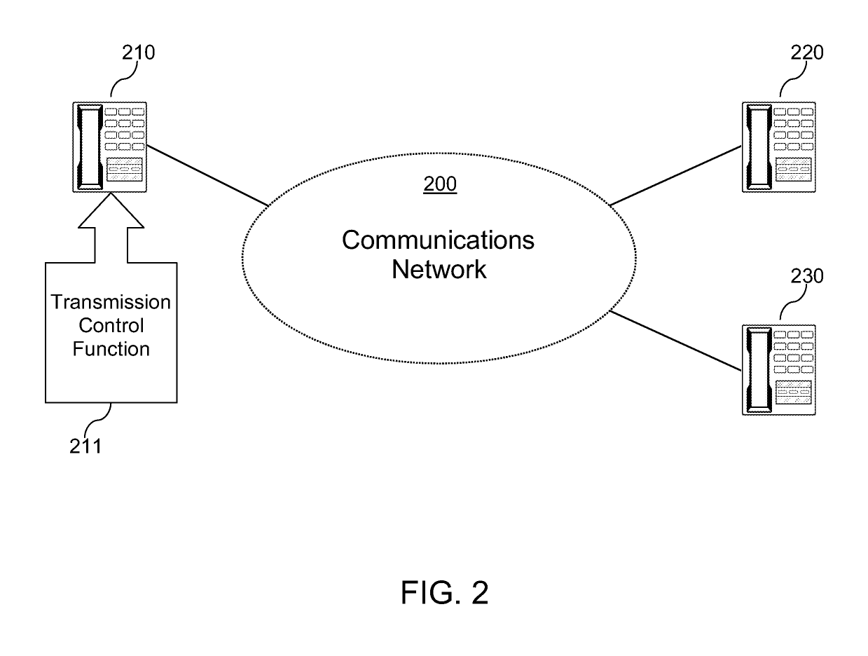

FIG. 2 is illustrative of a method of communication among communication modules according to an embodiment of the present invention. A communication network 200 is connected to a communication station 210 that is capable of switching between two or more states. In one embodiment, call-processing programs (such as network switches 120) may be configured to process state transitions in between the communication station 210 and one or more finite-state machines connected to the communication network 200.

In another embodiment of the present invention, the station 210 is an end-point in a communications network 200. The present state of the station 210 depends on whether the station 210 is presently initiating, engaging in, or receiving a transmission from another communication module. The station 210 may also be capable of having multiple lines of communication, such that a plurality of transmissions between the station 210 and other communication modules may be active simultaneously.

In yet another embodiment of the present technology, the station 210 is characterized as having three primary states. First, in an “idle” state, the station 210 is not currently engaging in any active transmissions with another network end-point. Alternatively, the station 210 may be in an “idle” state when there are open communication channels with one or more other communication modules, but all of said channels are “placed on hold” such that there are no transmissions that are presently being sent through those channels. Second, when the station 210 is in an “alerting” state, at least one incoming transmission is pending receipt by the station 210. The station 210 may or may not already be engaged in one or more active transmissions while in the “alerting” state. Finally, the station 210 may be in an “active” state, in which there are no pending incoming transmissions and there is at least one active transmission.

In the embodiment shown in FIG. 2, a transmission control function 211 is implemented in the station 210, giving it state-based functionality. The control function 211 may be configured to initiate a new transmission between the station 210 and a second communication module 220. Alternatively, if a third communication module 230 attempts to initiate a new transmission with the station 210, the control function 211 may be configured to redirect the new transmission from the station 210 to the second communication module 220, thus establishing a line of communication between the second module 220 and the third module 230.

With reference still to FIG. 2, the specific functionality of the control function 211 is dependent upon the present state of the station 210. In one embodiment, a user may execute the control function 211, but the function will either “initiate” a new transmission with or “redirect” a transmission to a second communication module 220 depending on, for instance, whether the station 210 is currently alerting a user about an incoming call from a third communication module 230. In another embodiment, the control function 211 may be configured such that execution of the function will result in an existing transmission between the station 210 and a communication module 230 being transferred to a communication module 220.

Principles of the present invention may be implemented by means of software modules, such as “soft phones” (i.e., computer programs implementing communication station end-point functionality), or through stand-alone hardware modules. The state-based communication module may be a common stationary phone that is connected to a communications network through a “hard line”, or the module may be a cellular (i.e., wireless) phone. In lieu of present day high speed Internet communications, the present invention may also be implemented using a VoIP phone or communications module. The invention may be used for transmitting audio, video, and other multimedia communications. Network end-point stations implementing embodiments of the present invention may be single-line or multi-line (i.e., supporting more than one communication at the same time).

A system according to an embodiment of the present invention may utilize a number of physical controls, such as push buttons on a keypad, that perform certain actions depending on the present state of a communication station. For example, a telephony end-point station can have a panel with several buttons, each being pre-programmed such that it is mapped to a specific network identification number (e.g., PSTN phone number, VoIP user identifier, etc.). When a user presses a one of such pre-programmed buttons, the system executes the transmission control function, which initiates one of a plurality of actions, depending on the present state of the communication station. The system may also have one or more sensory interfaces (such as a graphical interface) so as to communicate the present state of the communication station to a user. By having a requisite degree of familiarity with the functionality of the transmission control function, and by knowing the present state of the station, a user can physically execute a specific and desired operation of the control function by pushing a particular button on the keypad that implements said control function.

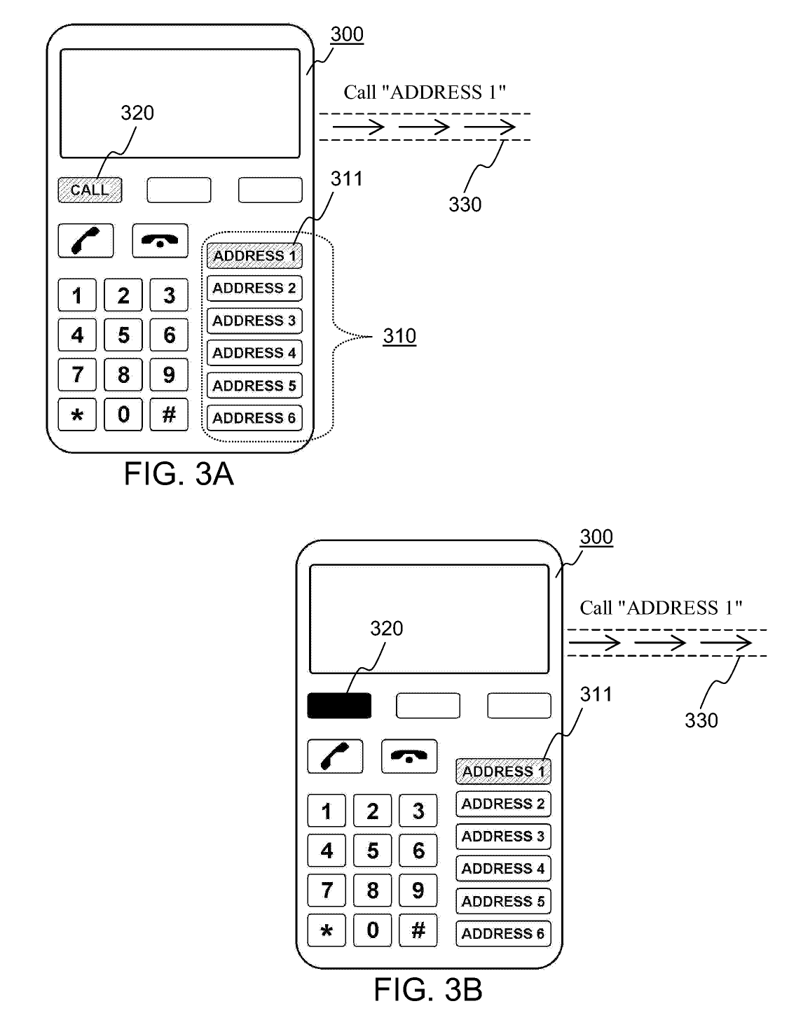

FIGS. 3A and 3B illustrate a method of state-based communication according to an embodiment of the present invention. FIG. 3A shows a communication station 300 having a plurality of pre-programmed address buttons 310. Each of said address buttons 310 may be mapped to a specific network address, e-mail address, user identification number, etc. In the embodiment shown in FIGS. 3A and 3B, a first address button 311 has been pre-programmed so as to be mapped to a specific network address (“ADDRESS 1”). The station 300 further includes a first user interface 320 that communicates state-based information to the user. The station 300 is currently in an “idle” state; when a user pushes the first address button 311, the station 300 initiates a call 330 to a communication module that is assigned to “ADDRESS 1”. The station 300 may then communicate to the user that the station has initiated a call 330 by means of the first user interface 320.

Thus, according to the embodiment shown in FIG. 3A, when a button is pressed in the “idle” state, an outgoing call 330 to the specified network address (“ADDRESS 1”) is initiated. This step is similar to the use of a button on a telephone that has been previously programmed to direct the telephone to dial a particular phone number (i.e., “speed-dialing”). However, according to the present embodiment, the functionality of the address button 311 does not remain constant after the call 330 has been initiated. Rather, the functionality of the address button 311 changes as a consequence of a change in state of the communication station 300.

In FIG. 3B, once the user has initiated a call 330 to “ADDRESS 1” by pushing the first address button 311, the first user interface 320 communicates to the user that a transmission is currently in progress. Further, the state of the station has changed from “idle” to “active”, because at least one active transmission is in progress between the station 300 and another communication module. As a result, the functionality of the first address button 311 has changed. In another embodiment, pressing the first address button 311 again, while the station is in the “active” state, will cause the active transmission between the station 300 and the communication module assigned to “ADDRESS 1” to be placed on “hold”. The first address button 311 could be further configured such that pressing it a third time would remove the “hold” on the active transmission. In this manner, the functionality of the first address button 311 changes depending on the present state of the station 300.

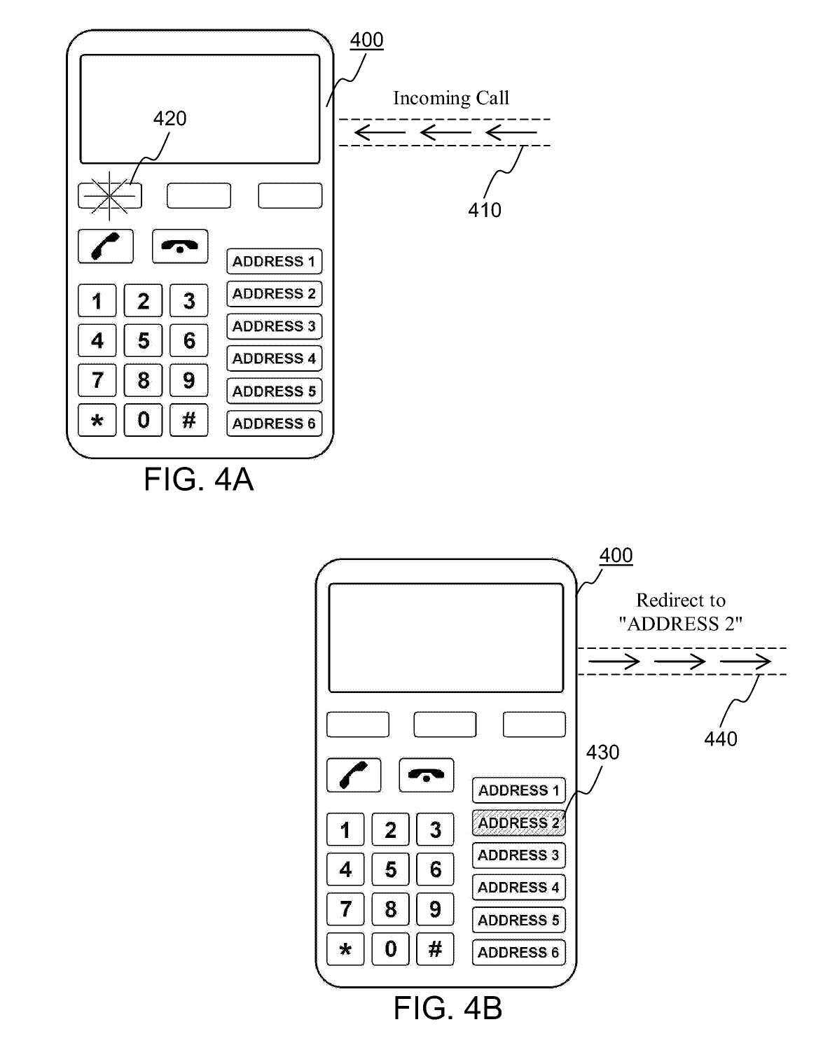

FIG. 4A shows an embodiment of the present invention in which a communication station 400 is presently in an “alerting” state due to an incoming call 410 from another communication module. The station 400 may be configured so as to alert a user as to the incoming call 410 by means of a user interface 420. The user interface 420 may communicate state-based information about the station 400 by utilizing a user's human sensory perception. For example, the user interface 420 may communicate information by means of a graphical display, emission of light, or creation of sounds audible by the human ear. Indeed, the user interface 420 may even use other means of communicating data depending on the needs of the users who are implementing the principles of the invention.

Once a user is alerted as to an incoming call 410, the user has the option of accepting or redirecting the incoming call 410. Thus, for instance, if the incoming call 410 consists of a voice transmission from another communication module, the user may listen to the incoming call 410. However, if the incoming call 410 should be directed to another party, the user may redirect the incoming call 410 to another network address such that said party may listen to the incoming call 410 at a different communication module. This latter example of an embodiment of the present invention is illustrated in FIG. 4B. The user is alerted as to an incoming call 410, and then decides that the incoming call 410 needs to be redirected to a different network address, “ADDRESS 2”. The user then pushes a pre-programmed address button 430 that has been mapped to “ADDRESS 2”. This action causes the station 400 to redirect 440 the incoming call 410 to “ADDRESS 2”.

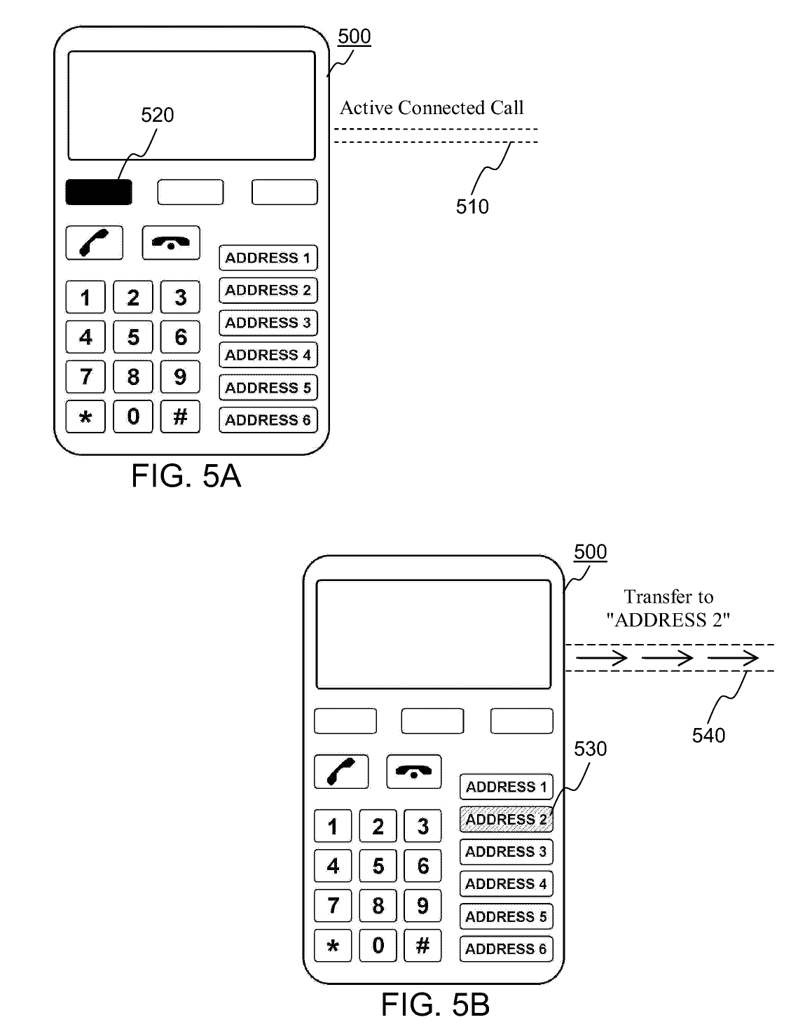

FIG. 5A shows an embodiment of the present invention in which a communication station 500 is presently in an “active” state due to an active connected call 510 with another communication module. The station 500 may utilize a user interface 510 to communicate to a user that the station 500 is currently in the “active” state. As shown in FIG. 5B, the user may press a pre-programmed address button 530 in order to transfer the call to another network address. In the demonstrated example, the pre-programmed address button 530 is mapped to “ADDRESS 2”. This action causes the station 500 to transfer 540 the active connected call 510 to “ADDRESS 2”.

Thus, according to one embodiment of the present invention, the pre-programmed address buttons may be configured so as to execute an “initiate” function, a “redirect” function, or a “transfer” (e.g., “blind-transfer”) function depending upon the present state of a multi-state communication module. In another embodiment, the address button may be configured so as to (1) initiate a transmission when the communication module is in an “idle” state, (2) redirect a transmission when the module is in an “alerting” state, and (3) transfer a transmission when the module is in an “active” state. The functionality of these buttons may be hardwired into the communication module, or the functionality may be implemented by means of an embedded software module. A person having ordinary skill in the art would be able to implement an embodiment of such a software module by designing the module using a high-level programming language, and then compiling the design into an executable file that is ultimately downloaded to a programmable system device (“PSD”). Although a myriad of possibilities exist as to how such software could be designed and configured, a simplified example of an embodiment of such a software module is demonstrated by the following pseudocode:

```
{
function getState is
  if Current_number_of_pending_incoming_calls > 0 then
    return “alerting”;
  end if;
  if Current_number_of_non_held_calls > 0 then
    return “active”;
  end if;
  return “idle”;
end function;
}
{
procedure PressButton(addr: address) is
  state := getState();
  if state == “alerting” then
    redirectCall(first_pending_incoming_call,addr);
  else if state == “active”;
    transferCall(first_unheld_call,addr);
  else
    startOutgoingCall(addr);
  end if;
end procedure;
}
```

It should be appreciated by those skilled in the art that this pseudocode is simply one example for configuring a software module according to an embodiment of the present technology, and is not meant to exclude other methods of implementation. Furthermore, this pseudocode is simply a functional example of such implementation, and as such, may not conform to the specific syntax requirements of a particular programming language. A vast number of programming languages may be used to implement an embodiment of the present invention, as long as such languages permit those skilled in the art to configure a software module such that the functionality of the embodiment may be implemented and executed.

In this example, the getState( ) function is a state detection algorithm that may be implemented by a 3-state device. Various alternative algorithms could be easily developed so as to utilize fewer or more states, depending on the type of device being used. For instance, a getState( ) function could be developed for use in a 4-state device used for conference calls. In addition to the aforementioned three states, a fourth state (“in conference”) could be added for when a person is talking simultaneously with two or more other people. Pressing a mapped address button during the “in conference” state could allow an additional person to be remotely added to the conference call.

The aforementioned embodiments are merely illustrative of some of the more prominent features and applications of the invention. The proposed solution is not limited to initiating transmissions with, or redirecting or transferring transmissions to network end-points assigned to specific network addresses or identification numbers. In another embodiment, a target address may be a service address (e.g., a voicemail address); thus, a communication workstation may be equipped with a “voicemail” button that, when pressed, either calls a particular voicemail account, redirects an incoming call to a voicemail, or transfers a caller to a voicemail message.

According to an alternative embodiment, a transmission control function is capable of specifying a particular object, module, or application on a particular network, server, central-station, or end-point station. Depending on the current state of the end-point station, different applications may be invoked. For example, a VoIP station can have a button that is mapped to a specific parking center identification number. Pressing the “parking center” button in an “on-call” or “alerting” state will cause the calling party to be connected to the parking center, while pressing this button in the “idle” state could result in a call being placed to the park center. Indeed, the system could be configured such that pressing the “parking center” button in the “idle” state may be used to retrieve a parked call, such that a previously interrupted or paused conversation may be continued.

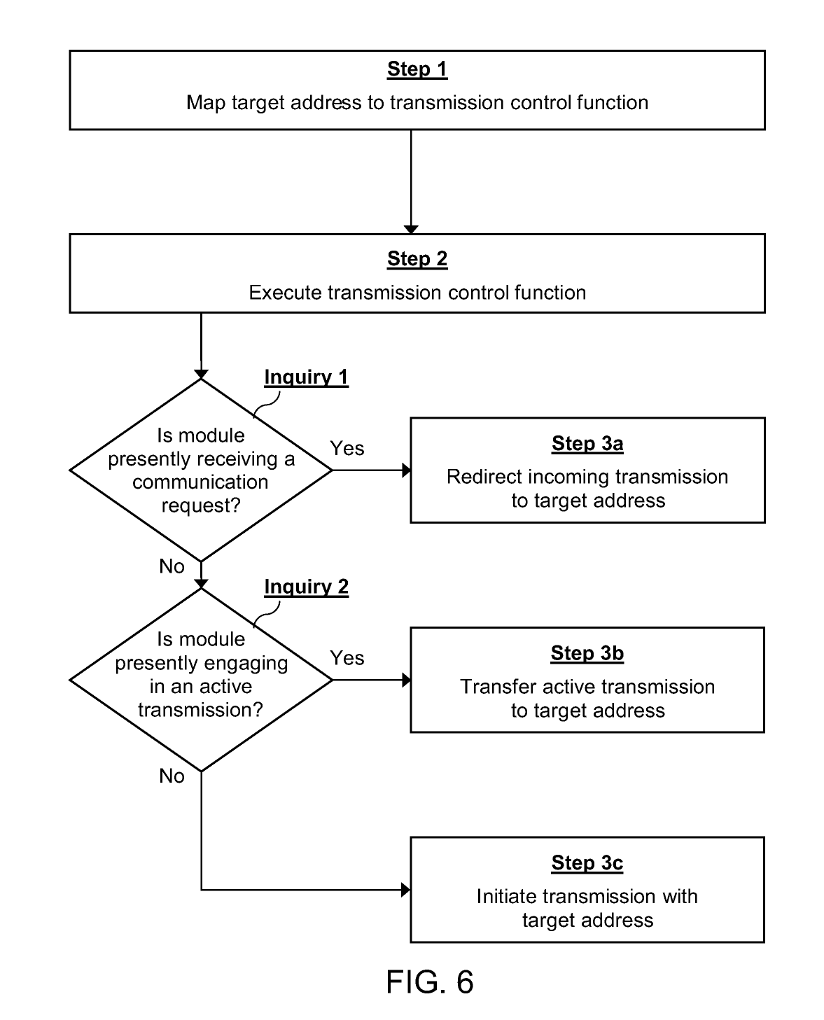

FIG. 6 illustrates a method of implementing an embodiment of the present invention. In STEP 1, a target address is mapped to a transmission control function. However, it is should be appreciated by those skilled in the art that STEP 1 is not limited to a single target address or a single transmission control function. For instance, in one embodiment of the present technology, a plurality of transmission control functions may be implemented, each being mapped to a different target address. Execution of the transmission control function, in STEP 2, causes the function to initiate INQUIRY 1, wherein the function analyzes whether the multi-state communication module is presently receiving a communication request, and if so, the incoming transmission is redirected to the mapped target address in STEP 3a. If the module is not receiving a communication request, the control function initiates INQUIRY 2, wherein if the module is presently engaging in an active transmission, the control function next executes STEP 3b, such that the transmission is transferred (e.g., “blind-transferred”) to the mapped target address. If on the other hand the module is not presently receiving any communication requests or engaging in any active transmissions, execution of the transmission control function in STEP 2 will cause the module to initiate a new transmission with the target address, in STEP 3c.

Those skilled in the art should appreciate that the embodiment illustrated in FIG. 6 may be expanded pursuant to the communication needs of those implementing embodiments of the present technology. For example, the multi-state communication module may be prompted to receive a transmission before any state-based communications occur. In one embodiment, the multi-state communication module is electrically powered, and the module is prompted to receive a transmission by being provided electrical power and being granted access to one or more communication networks. In another embodiment of the present invention, the multi-state communication module is assigned an address on a single communications network (e.g., a traditional PSTN address).

In an alternative embodiment, the multi-state communication module is assigned an address on a first communications network as well as an address on a second communications network, such that the multi-state communication module may receive transmissions from multiple networks. For example, the multi-state communication module may be assigned a phone number on a PSTN network, and may be further assigned an identification ID on a VoIP network. The module may then receive transmissions sent from other network addresses from within these networks. In yet another embodiment, the multi-state communication module may be configured so as to initiate, forward, dispatch, or even mediate, transmissions between two other communication modules, whether these other communication modules are part of the same or different communication networks.

The embodiment illustrated in FIG. 6 is merely illustrative of how principles of the present invention may be implemented by those skilled in the art. However, other methods of implementation may be utilized depending upon the type of communications media being used, and the objectives of those who practice the invention. Further, each area of application may be modified according to the “states” defined in that area. For instance, in another embodiment, a VoIP implementation can be modified by integrating the “state” information with the “presence” information available. To illustrate, a control button with the user identification “A” may be illuminated differently depending on the presence/state information of a communication module that is used by user A, and the function of the control button may depend not only upon the state of this module, but also on the state of user A. As an example of this embodiment, a user is “on call” with X, and the control button on the user's end-point workstation is configured with identification “A”. By pressing this button, the user can “blind-transfer” X to A. If the button “A” shows the state/presence of “A”, and that state is currently “busy”, then pressing this button may result in a different action, such as sending user A an instant message (“IM”) that states, “I need to transfer a call to you.”

As shown from the above embodiments and examples, the present invention provides a number of advantages over the prior art. For instance, although modern telephony end-points that utilize a set of “address” buttons for purposes of speed-dialing, those buttons always perform the same function (i.e., dialing a specific number), and this function is not “state” dependent. In contrast, embodiments of the present invention allow the functionality of “address” buttons to change depending on the current state of an end-point. Indeed, various methods of implementation would provide a valuable utility to end-users, because certain functions (e.g., dialing a number or transmitting a communication request) make sense only if an end-point is in a specific state. In addition, since end-point stations in communication networks presently lack the ability to modify button action in response to the current state of a communication end-point, the functionality of such buttons remains static over time, thus limiting the functionality that a communication station may realize. Principles of the present invention, however, would provide an end-point station with a greater degree of functionality, without the need for increasing the number of physical buttons and controls that the station utilizes. Thus, various embodiments of the invention provide methods and systems of state-based communications that are characterized as having a relatively high degree of functionality and extensibility without adding significantly to the cost or complexity of implementation.

Having thus described various embodiments of the invention, it will now be understood by those skilled in the art that many changes in construction, implementation and design, and widely differing embodiments and applications of the invention will suggest themselves without departure from the spirit and scope of the invention. The disclosures and the description herein are purely illustrative and are not intended to be in any sense limiting. Rather, the invention is to cover all modifications, equivalents, and alternatives falling within the spirit and scope of the invention as defined by the appended claims.

I claim:

1. A system comprising:
a first communication module that switches between different communication states; and
a communication control function mapped to a target address that is assigned to a second communication module;
wherein the present functionality of the control function is dependent upon the present state of the first communication module.

2. The system of claim 1, wherein the control function is assigned an initiating function when the first communication module is in an idle state, such that executing the control function initiates a transmission to the second communication module.

3. The system of claim 1, wherein the control function is assigned a redirecting function when the first communication module is in an alerting state, such that executing the control function redirects an incoming transmission to the second communication module.

4. The system of claim 1, wherein the control function is assigned a transferring function when the first communication module is in an on-call state such that executing the control function transfers an active transmission to the second communication module.

5. The system of claim 1, wherein the present functionality of the control function further depends on a present state of the second communication module.

6. The system of claim 1, wherein the first communication module detects whether the second communication module is available to accept a transmission, and communicates this information to a user.

7. The system of claim 5, wherein the first communication module detects whether the second communication module is available to accept a transmission, and communicates this information to a user.

8. The system of claim 1, wherein the system may simultaneously support a plurality of active transmissions.

9. The system of claim 1, further comprising a display pad having a plurality of input buttons and at least one address button, and wherein the control function is executed by pressing an address button on the display pad.

10. The system of claim 1, further comprising a user interface that communicates a present state of the first communication module to a user.

11. The system of claim 1, wherein the target address is an address in a PSTN telephony network.

12. The system of claim 1, wherein the target address is an address in a PBX network.

13. The system of claim 1, wherein the target address is assigned to an identification number in a VoIP network.

14. A communication control system having state-dependent functionality, the system comprising:
a primary communication module capable of switching between different states, wherein said primary communication module is assigned a first address; and
a transmission control function configured to initiate, redirect and transfer transmissions to a second address assigned to a target communication module, and configured to execute a specific function depending upon a present state of the primary communication module.

15. The system of claim 14, wherein the transmission control function is mapped to a pre-programmed address button.

16. The system of claim 14, wherein execution of the transmission control function attempts to initiate a transmission with the target communication module when the primary communication module is not engaging in any other active transmissions and is not receiving any new transmissions.

17. The system of claim 14, wherein execution of the transmission control function attempts to redirect a transmission to the target communication module when the primary communication module is receiving a new transmission from another communication module.

18. The system of claim 14, wherein execution of the transmission control function attempts to transfer an active transmission to the target communication module when the primary communication module is engaging in an active transmission with another communication module.

19. A method of state-dependent communication, comprising:
mapping a network address to a transmission control function, wherein the network address is assigned to a target communication module; and
executing the transmission control function, wherein said executing step results in the transmission control function:
redirecting a transmission to the target communication module when a primary communication module is receiving a communication request from another communication module;
transferring an active transmission to the target communication module when the primary communication module is engaging in the active transmission with another communication module; and
initiating a transmission with the target communication module when the primary communication module is not engaging in any other active transmissions and is not receiving any new transmissions.

20. The method of claim 19, further comprising prompting the primary communication module to receive a transmission.

21. The method of claim 19, further comprising detecting whether the target communication module is available to accept a transmission.
